(19) United States
(12) Patent Application Publication
(10) Pub. No.: US 2024/0204979 A1
(43) Pub. Date: Jun. 20, 2024

(54) SYSTEMS AND METHODS FOR DYNAMIC USE OF TIME DIVISION DUPLEXING

(71) Applicant: Verizon Patent and Licensing Inc., Basking Ridge, NJ (US)

(72) Inventors: Xin WANG, Morris Plains, NJ (US); Susan Wu SANDERS, Bridgewater, NJ (US); Jin YANG, Orinda, CA (US)

(73) Assignee: Verizon Patent and Licensing Inc., Baskin g Ridge, NJ (US)

(21) Appl. No.: 18/068,929

(22) Filed: Dec. 20, 2022

(51) Int. Cl. H04L 5/14; H04W 28/08

(52) U.S. Cl. CPC H04L 5/1469; H04W 28/0942; H04W 28/095

(57) ABSTRACT

In some implementations, a device may generate a traffic demand prediction associated with a radio access network (RAN). The device may determine, based on the traffic demand prediction, that a first set of cells of the RAN are to be configured with a first time-division duplexing (TDD) configuration that differs from a second TDD configuration configured for one or more other cells of the RAN. The device may identify a second set of cells of the RAN that are to be configured to mitigate interference in the first set of cells. The device may provide an interference mitigation configuration to the second set of cells to cause the second set of cells to mitigate interference in the first set of cells.

### BACKGROUND

Time-division duplexing (TDD) is a communication technique according to which uplink communications and downlink communications are communicated on a same frequency band at different time slots. In general, a TDD configuration may indicate a slot format for each slot in a given frame. For example, a TDD configuration may indicate that a first set of slots in a given frame is to be used for downlink and that a second set of slots in the frame is to be used for uplink, and, in some cases, that a third set of slots is flexible (e.g., a set of slots that can be dynamically configured as uplink slots or downlink slots at a later time).

### BRIEF DESCRIPTION OF THE DRAWINGS

FIGS. 1A-1D are diagrams of an example associated with dynamic use of time division duplexing (TDD).

FIG. 2 is a diagram of an example environment in which systems and/or methods, described herein, can be implemented.

FIG. 3 is a diagram of example components of a device associated with dynamic use of TDD.

FIG. 4 is a flowchart of an example process associated with dynamic use of TDD.

### DETAILED DESCRIPTION OF EXAMPLE EMBODIMENTS

The following detailed description of example implementations refers to the accompanying drawings. The same reference numbers in different drawings may identify the same or similar elements.

Typically, under normal operating conditions, a percentage of a total volume of traffic in a wireless communication system that is uplink traffic is lower than a percentage of the total volume of traffic that is downlink traffic. For example, under normal operating conditions, uplink traffic may be approximately 10% of a total traffic volume in a wireless communication system at any given time. However, in some geographical areas covered by the wireless communication system, uplink traffic may (e.g., temporarily) increase such that uplink traffic is a significant portion (e.g., 50% or more) of the overall traffic volume. Such a scenario may occur during particular time windows in a geographical area around or near, for example, a stadium, a venue, or an event site, among other examples. Further, a service supported by the wireless communication system (e.g., an augmented reality (AR) service, a virtual reality (VR) service, or the like) may increase uplink demand in the wireless communication system.

Some wireless communication systems support flexible uplink/downlink timing for time-division duplexing (TDD). This enables the network to change symbols or slots in a given cell between the uplink and downlink according to requirements at a given time. For example, the number of uplink slots in a frame can be increased while the number of downlink slots in the frame is decreased if the volume of uplink traffic increases relative to the volume of downlink traffic, as described above. Such TDD configuration can be used to improve network performance by, for example, providing flexibility to dynamically adjust to traffic demands. Notably, such flexible TDD configuration can cause TDD configurations to differ among cells in close proximity within the wireless communication system. For example, a frame may include ten slots—slot 0 through slot 9. Here, a first cell may be configured with a first TDD configuration indicating that slots 0 through 3 are downlink slots, slots 4 and 5 are uplink slots, and slots 6 through 9 are downlink slots. In this example, a second (nearby) cell may be (e.g., dynamically) configured with a second TDD configuration indicating that slots 0 through 3 are downlink slots, slots 4 through 7 are uplink slots, and slots 8 and 9 are downlink slots (e.g., a direction of slots 6 and 7 differ between the first and second TDD configurations).

However, having different TDD configurations on nearby cells can create significant interference (e.g., cross-link interference), which degrades network performance. Continuing with the above example, the direction of slots 6 and 7 differ between the first and second TDD configurations—slots 6 and 7 are downlink slots according to the first TDD configuration and are uplink slots according to the second TDD configuration. With such configurations, downlink transmissions in the first cell in slots 6 and 7 may interfere with uplink transmissions in the second cell in slots 6 and 7. For example, the downlink transmissions in the first cell may have a high transmit power (e.g., as compared to uplink transmissions in the second cell), which can cause interference with respect to the uplink transmissions in the second cell in slots 6 and 7. Such interference caused by different TDD configurations can significantly degrade network throughput (e.g., uplink throughput), thereby reducing overall network performance.

Some implementations described herein enable dynamic use of TDD. In some implementations, a device (e.g., a network control device) may generate a traffic demand prediction associated with a radio access network (RAN). The device may then determine, based on the traffic demand prediction, that a first set of cells of the RAN are to be configured with a first TDD configuration that differs from a second TDD configuration configured for one or more other cells of the RAN. The device may then identify a second set of cells of the RAN that are to be configured to mitigate interference in the first set of cells and may provide an interference mitigation configuration to the second set of cells to cause the second set of cells to mitigate interference in the first set of cells. In this way, interference between cells with different TDD configurations can be mitigated, meaning that a TDD spectrum can be used dynamically so as to meet a traffic demand while reducing performance degradation (e.g., reducing throughput loss that could otherwise be caused by the different TDD configurations). Additional details are provided below.

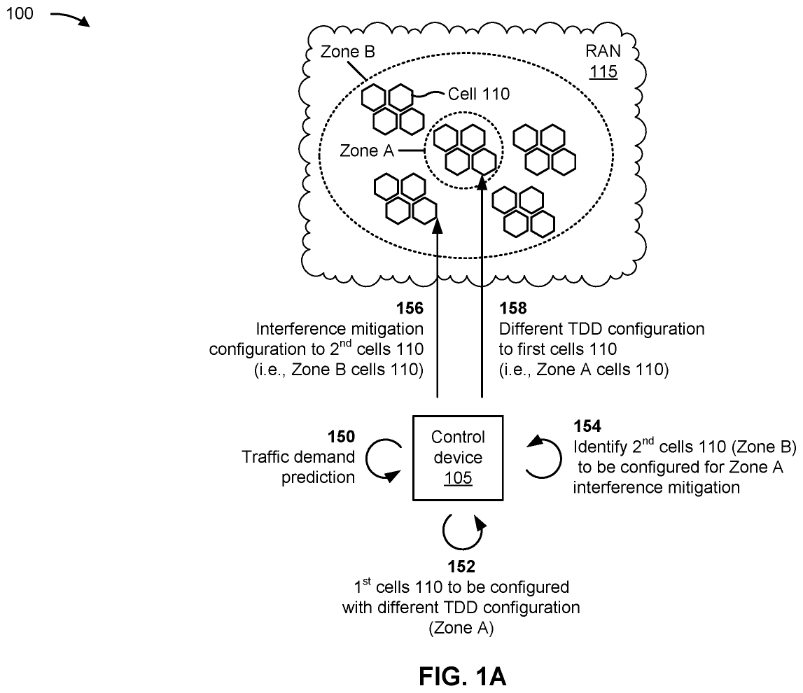

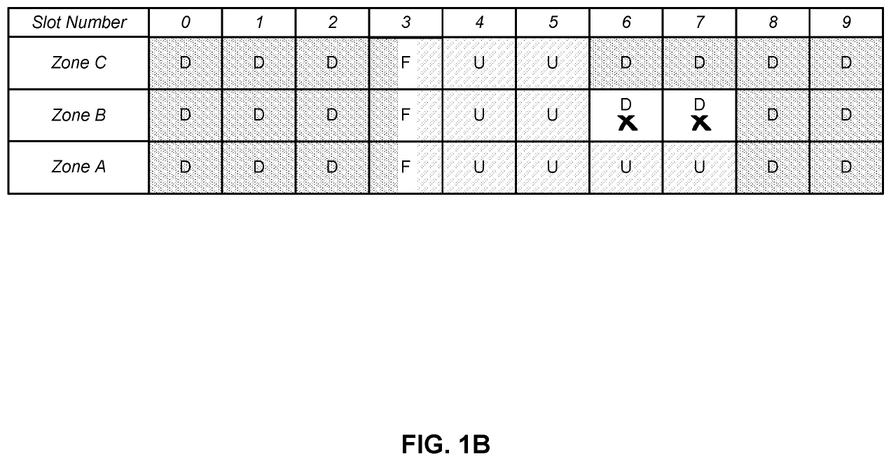

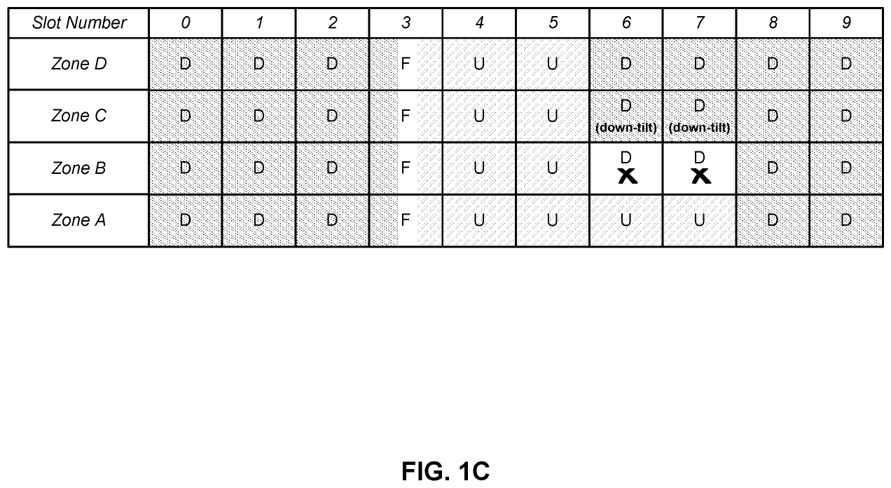

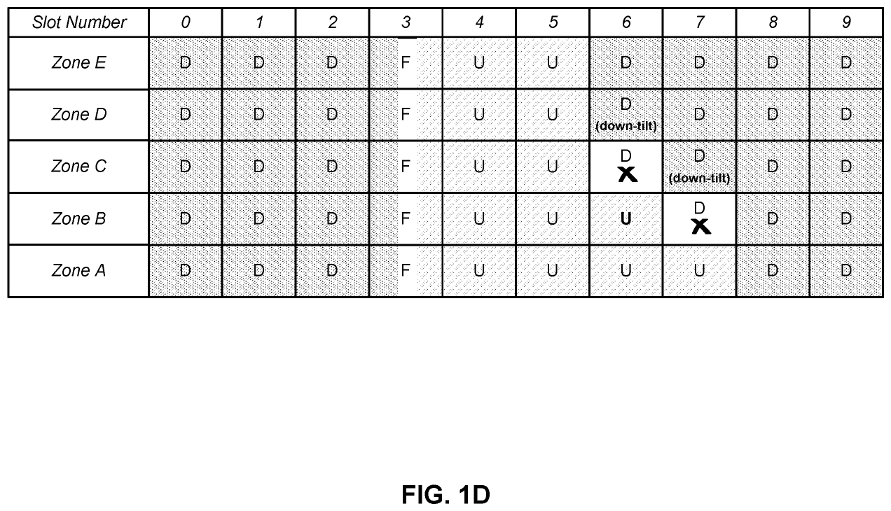

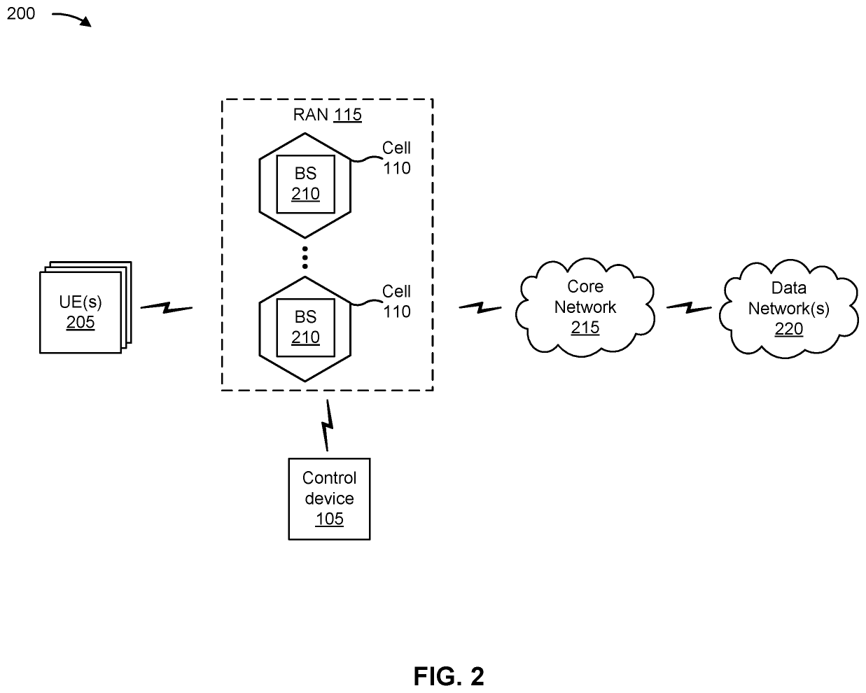

FIGS. 1A-1D are diagrams of an example 100 associated with dynamic use of TDD. As shown in FIGS. 1A-1D, example 100 includes a control device 105 and a group of cells 110 in a RAN 115. In some implementations, each of the cells 110 may be provided and/or operated by a network device, such as a base station (not shown in FIG. 1A). The control device 105 is a device configured to perform operations associated with dynamic use of TDD, as described herein. Additional details regarding the control device 105, the cells 110, and the RAN 115 are provided with respect to FIG. 2.

As shown at reference 150, the control device 105 may generate a traffic demand prediction. A traffic demand prediction is a prediction (e.g., a forecast) of a traffic demand in the RAN 115. For example, the traffic demand prediction may indicate a predicted ratio or a predicted percentage of uplink traffic or downlink traffic expected in a given cell 110 at a given time. Such a traffic demand prediction may be used to, for example, identify cells 110 that should be configured with a different TDD configuration (e.g., so as to handle an increased amount of uplink traffic), as described below.

In some implementations, the traffic demand prediction may be associated with a particular geographical area (e.g., an area covered by one or more cells 110). Additionally, or alternatively, the traffic demand prediction may be associated with a particular time window (e.g., on a particular date, on a particular day of the week, or the like). As a particular example, the traffic demand prediction may indicate that the amount of uplink traffic in a particular geographical area is expected to be 50% of overall traffic volume (e.g., as compared to typically being approximately 10% of the overall traffic volume) in a particular cell 110 during a particular two hour time window on a particular date.

In some implementations, the control device 105 may generate the traffic demand prediction based on one or more historical performance metrics associated with the cells 110 of the RAN 115. That is, the control device 105 may, in some implementations, generate the traffic demand prediction based on historical performance data associated with the cells 110 of the RAN. The one or more historical performance metrics may include, for example, a downlink physical resource block (PRB) usage metric (e.g., a metric indicating a usage rate of downlink PRBs in a cell 110 during a particular past time period). As another example, the one or more historical performance metrics may include an uplink PRB usage metric (e.g., a metric indicating a usage rate of uplink PRBs in a cell 110 during a particular past time period). As another example, the one or more historical performance metrics may include a downlink data volume metric (e.g., a metric indicating a percentage of traffic in a cell 110 that was downlink traffic during a particular past time period). As another example, the one or more historical performance metrics may include an uplink data volume metric (e.g., a metric indicating a percentage of traffic in a cell 110 that was uplink traffic during a particular past time period).

Additionally, or alternatively, the control device 105 may generate the traffic demand prediction based on event information associated with an area corresponding to at least one cell 110. The event information may include information associated with an event, expected to occur at or near the at least one cell 110, that could impact traffic demand in the at least one cell 110. As an example, the event information may include information associated with event that is expected at or near a landmark (e.g., a stadium, a venue, or the like) that is within or near an area covered by the at least one cell 110. Here, the event information may include associated with the event, such as information indicating an expected increase in demand for a particular type of traffic (e.g., an expected increase in uplink traffic), an expected increase in a number of users in the cell, or a time period associated with the event (e.g., a date, a start time, end time, or the like), among other examples.

In some implementations, the control device 105 may generate the traffic demand prediction based on a traffic demand prediction model. For example, the control device 105 may receive the one or more historical performance metrics associated with the RAN 115. Here, the control device 105 may apply an artificial intelligence (AI) technique or a machine learning (ML) technique to the historical performance metrics to generate a traffic demand prediction model that can be utilized to generate traffic demand predictions associated with the RAN 115. In some implementations, the traffic demand prediction model may be generated based on event information in addition or in alternative to the one or more historical performance metrics.

In some implementations, the traffic demand prediction indicates a start time and an end time associated with the traffic demand prediction. For example, the traffic demand prediction may indicate that uplink traffic is expected to be at least 50% of the overall traffic volume in a first set of cells 110 (e.g., in or near a particular geographical area) from 8:00 p.m. to 11:00 p.m. (e.g., on one or more particular dates). In some implementations, the start and end times associated with the traffic demand prediction may indicate a start and end time, respectively, for implementation of a TDD configuration in the first set of cells, as described below.

As shown at reference 152, the control device 105 may determine, based on the traffic demand prediction, that a first set of cells 110 of the RAN 115 are to be configured with a first TDD configuration that differs from a second TDD configuration configured for one or more other cells 110 of the RAN 115. That is, the control device 105 may determine a first set of cells 110 for which a TDD configuration is to be updated or modified such that the TDD configuration used in the first set of cells 110 is different from a TDD configuration used in other cells in the RAN 115. As one example, the traffic demand prediction may indicate that uplink traffic demand is expected to satisfy a threshold (e.g., that uplink traffic is expected to be at least 50% of overall traffic volume) in a first set of cells 110. Here, the control device 105 may determine that the first set of cells 110 is to be configured with a first TDD configuration that utilizes a 1:1 downlink-to-uplink slot ratio, rather than a second TDD configuration that utilizes a 4:1 downlink-to-uplink slot ratio (e.g., a default TDD configuration used by cells 110 in the RAN 115). In example 100, an area corresponding to the first set of cells 110 (e.g., the cells 110 with an expected increase in uplink traffic) is identified as Zone A.

In some implementations, the first TDD configuration has a higher uplink slot to downlink slot ratio than the second TDD configuration configured for the one or more other cells. For example, the first TDD configuration may indicate that each frame includes five uplink slots and five downlink slots, while the second (default) TDD configuration may indicate that each frame includes two uplink slots and eight downlink slots. In some implementations, such a TDD configuration may be utilized so as to increase capacity for uplink traffic in the first set of cells, as dictated by the traffic demand prediction. In some implementations, a format of one or more slots in the first TDD configuration is different from a format of one or more corresponding slots in the second TDD configuration configured for the one or more other cells. For example, the first TDD configuration may indicate, for a given frame, that slots 0 through 3 are downlink slots, slots 4 through 7 are uplink slots, and slots 8 and 9 are downlink slots, while the second TDD configuration may indicate that slots 0 through 3 are downlink slots, slots 4 and 5 are uplink slots, and slots 6 through 9 are downlink slots (e.g., a direction of slots 6 and 7 differ between the first and second TDD configurations).

In some implementations, the first TDD configuration indicates a start time associated with the first TDD configuration and an end time associated with the first TDD configuration. That is, the first TDD configuration may indicate a time period during which the first TDD configuration is to be implemented in the first set of cells 110. Here, the start time and the end time may correspond to or be based on the start time and the end time associated with the traffic demand prediction. For example, the start time and the end time associated with the first TDD configuration may correspond to a start time and an end time, respectively, of a predicted increase in uplink traffic in the first set of cells 110 as indicated by the traffic demand prediction.

As shown at reference 154, the control device 105 may identify a second set of cells 110 of the RAN 115 that are to be configured to mitigate interference in the first set of cells 110. That is, the control device 105 may identify one or more other cells 110 that are to be configured to mitigate interference caused in the first set of cells 110 (e.g., due to the different TDD configuration being implemented in the first set of cells 110.). In example 100, an area corresponding to the second set of cells 110 (e.g., the cells 110 to be configured so as to mitigate interference in Zone A) is identified as Zone B.

In some implementations, the control device 105 may identify the second set of cells 110 based on a set of characteristics associated with a given cell 110. That is, the control device 105 may determine that a given cell 110 should be included in the second set of cells 110 (e.g., the set of cells 110 to be configured so as to mitigate interference to the first set of cells 110) based on a set of characteristics associated with the given cell 110. The set of characteristics for the given cell 110 may include, for example, a location of the cell 110, a transmit power of the cell 110, an azimuth associated with the cell 110, an antenna pattern associated with the cell 110, a morphology associated with the cell 110, or a propagation model associated with the cell 110, among other examples.

In some implementations, the control device 105 may identify the second set of cells 110 based on a determination that a given cell 110 would cause some amount of interference to the first set of cells 110. For example, the control device 105 may store or have access to an interference prediction model that receives, as input, information associated with a set of characteristics of a cell 110 and provides, as an output, an interference prediction (e.g., a predicted amount of interference) caused by the cell 110 to one or more other cells 110. Here, if the interference prediction indicates that the cell 110 would cause at least a threshold amount of interference to the first set of cells 110, then the control device 105 may include the cell 110 in the second set of cells. In some implementations, the control device 105 may identify one or more cells 110 for inclusion in the second set of cells 110 in a similar manner.

As shown at reference 156, the control device 105 may provide an interference mitigation configuration to the second set of cells 110. The interference mitigation configuration is a configuration that is to cause the second set of cells 110 to mitigate interference caused by the second set of cells 110 in the first set of cells 110. For example, the interference mitigation configuration may indicate one or more slots that are not to be scheduled in the second set of cells 110. That is, the interference mitigation configuration may indicate that one or more slots in a given frame are not to be scheduled in the second set of cells 110 such that the one or more slots are not used for transmission of wireless communication in the second set of cells 110. As another example, the interference mitigation configuration may indicate one or more slots in which an interference mitigation technique is to be applied. That is, the interference mitigation configuration may indicate one or more slots in which one or more interference mitigation techniques are to be applied by the second set of cells 110. The one or more interference mitigation techniques may include, for example, beamforming so as to reduce interference in Zone A, antenna tilting (e.g., physical down-tilting, electrical down-tilting, or the like) so as to reduce interference in Zone A, or transmit power reduction so as to reduce interference in Zone A, among other examples. As another example, the interference mitigation configuration may indicate a slot format for one or more slots. For example, the interference mitigation configuration may indicate that, for a given frame, a particular slot is to be used as an uplink slot (e.g., rather than being used as a downlink slot as indicated by a default TDD configuration).

In some implementations, the control device 105 may determine the interference mitigation configuration based on an interference threshold for the first set of cells 110. For example, the control device 105 may identify an interference threshold associated with the first set of cells 110 (e.g., a maximum allowable amount of interference). The control device 105 may then determine the interference mitigation configuration based on the interference threshold. That is, the control device 105 may determine the interference mitigation configuration so as to prevent interference to the first set of cells 110 from exceeding the interference threshold.

In some implementations, the interference mitigation configuration indicates a start time associated with the interference mitigation configuration and an end time associated with the interference mitigation configuration. That is, the interference mitigation configuration may indicate a time period during which the interference mitigation configuration is to be implemented in the second set of cells 110. Here, the start time and the end time may correspond to or be based on the start time and the end time associated with the traffic demand prediction or the start time and the end time associated with the first TDD configuration. For example, the start time and the end time associated with the interference mitigation configuration may correspond to a start time and an end time, respectively, of a predicted increase in uplink traffic in the first set of cells 110 as indicated by the traffic demand prediction.

In some implementations, the control device 105 may provide interference mitigation configurations to multiple (different) sets of cells 110. For example, the control device 105 may identify a third set of cells 110 that are to be configured to mitigate interference in the first set of cells 110, and may provide a second interference mitigation configuration to the third set of cells 110 to cause the third set of cells 110 to mitigate interference in the first set of cells 110. In this way, the control device 105 may identify multiple interference mitigation zones. In some implementations, an interference mitigation configuration configured in a set of cells 110 nearer to the first set of cells 110 may be different from an interference mitigation configuration for another set of cells 110 that is further from the first set of cells 110. Particular examples of interference mitigation configurations for one or more interference mitigation zones are provided below with respect to FIGS. 1B-1D.

As shown at reference 158, the control device 105 may provide the first TDD configuration to the first set of cells 110. That is, the control device 105 may provide the first TDD configuration to the first set of cells 110.

In this way, the control device 105 may identify and configure a first set of cells 110 (e.g., corresponding to Zone A) with a dynamic TDD configuration based on a traffic demand prediction, and may identify and configure a second set of cells 110 (e.g., corresponding to Zone B) to mitigate interference caused in the first set of cells 110 by the second set of cells 110, thereby enabling a dynamic traffic pattern to be managed with improved network performance (e.g., by reducing interference in the first set of cells 110).

FIGS. 1B-1D are diagrams illustrating examples of TDD configurations associated with dynamic use of TDD as described herein.

In the example shown in FIG. 1B, a control device 105 has determined, based on a traffic demand prediction associated with a RAN 115, that a first set of cells 110 (Zone A) is to be configured with a first TDD configuration according to which, for a given frame, slots 0 through 2 are downlink slots, slot 3 is a flexible slot, slots 4 through 7 are uplink slots, and slots 8 and 9 are downlink slots. Here, the first TDD configuration differs from a second TDD configuration (e.g., a default TDD configuration used by other cells 110) according to which, for a given frame, slots 0 through 2 are downlink slots, slot 3 is a flexible slot, slots 4 and 5 are uplink slots, and slots 6 through 9 are downlink slots. In this example, the control device 105 identifies a second set of cells 110 (Zone B) that are to provide interference mitigation for the first set of cells 110, and provides the second set of cells 110 with an interference mitigation configuration indicating that slots 6 and 7 in a given frame are not to be scheduled in the second set of cells 110. Here, the interference mitigation configuration, when applied in the second set of cells 110, prevents slots 6 and 7 from being scheduled in the second set of cells 110 so as to reduce interference to the first set of cells 110. In this way, interference caused by the second set of cells 110 to the first set of cells 110 may be reduced (e.g., by preventing downlink transmissions in the second set of cells 110 in slots 6 and 7). Further, the interference mitigation configuration may reduce interference of uplink transmissions in the first set of cells 110 near an edge of Zone A from interfering with downlink communication to nearby devices in Zone B. As further shown, cells 110 not included in the first set of cells 110 or the second set of cells 110 (e.g., cells 110 in Zone C, outside of Zone A and Zone B) may operate normally according to the second (e.g., default) TDD configuration.

In the example shown in FIG. 1C, a control device 105 has determined, based on a traffic demand prediction associated with a RAN 115, that a first set of cells 110 (Zone A) is to be configured with a first TDD configuration according to which, for a given frame, slots 0 through 2 are downlink slots, slot 3 is a flexible slot, slots 4 through 7 are uplink slots, and slots 8 and 9 are downlink slots. Here, the first TDD configuration differs from a second TDD configuration (e.g., a default TDD configuration used by other cells 110) according to which, for a given frame, slots 0 through 2 are downlink slots, slot 3 is a flexible slot, slots 4 and 5 are uplink slots, and slots 6 through 9 are downlink slots. In this example, the control device 105 identifies a second set of cells 110 (Zone B) that are to provide interference mitigation for the first set of cells 110, and provides the second set of cells 110 with a first interference mitigation configuration indicating that slots 6 and 7 in a given frame are not to be scheduled in the second set of cells 110. Here, the first interference mitigation configuration, when applied in the second set of cells 110, prevents slots 6 and 7 from being scheduled in the second set of cells 110 so as to reduce interference to the first set of cells 110. In this way, interference caused by the second set of cells 110 to the first set of cells 110 may be reduced (e.g., by preventing downlink transmissions in the second set of cells 110 in slots 6 and 7). Further, in this example, the control device 105 identifies a third set of cells 110 (Zone C) that are to provide interference mitigation for the first set of cells 110, and provides the third set of cells 110 with a second interference mitigation configuration indicating that antenna tilting (e.g., down-tilting) is be applied in slots 6 and 7 in a given frame in the third set of cells 110. Here, the second interference mitigation configuration, when applied in the third set of cells 110, utilizes antenna tilting in slots 6 and 7 so as to reduce interference to the first set of cells 110. In some implementations, dynamic beam forming can additionally or alternatively be used within slots 6 and 7 so as to transmit with lower power in the direction towards the first set of cells 110 (Zone A) and with full power in the direction away from the first set of cells 110. In this way, interference caused by the third set of cells 110 to the first set of cells 110 may be reduced. As further shown, cells 110 not included in the first set of cells 110, the second set of cells 110, or the third set of cells (e.g., cells 110 in Zone D, outside of Zone A, Zone B, and Zone C) may operate normally according to the second (e.g., default) TDD configuration.

In the example shown in FIG. 1D, a control device 105 has determined, based on a traffic demand prediction associated with a RAN 115, that a first set of cells 110 (Zone A) is to be configured with a first TDD configuration according to which, for a given frame, slots 0 through 2 are downlink slots, slot 3 is a flexible slot, slots 4 through 7 are uplink slots, and slots 8 and 9 are downlink slots. Here, the first TDD configuration differs from a second TDD configuration (e.g., a default TDD configuration used by other cells 110) according to which, for a given frame, slots 0 through 2 are downlink slots, slot 3 is a flexible slot, slots 4 and 5 are uplink slots, and slots 6 through 9 are downlink slots. In this example, the control device 105 identifies a second set of cells 110 (Zone B) that are to provide interference mitigation for the first set of cells 110, and provides the second set of cells 110 with a first interference mitigation configuration indicating that, in a given frame, slot 6 is configured as an uplink slot and that slot 7 is not to be scheduled in the second set of cells 110. Further, in this example, the control device 105 identifies a third set of cells 110 (Zone C) that are to provide interference mitigation for the first set of cells 110, and provides the third set of cells 110 with a second interference mitigation configuration indicating that, for a given frame, slot 6 is not to be scheduled and that antenna tilting (e.g., down-tilting) is be applied in slot 7. Further, in this example, the control device 105 identifies a fourth set of cells 110 (Zone D) that are to provide interference mitigation for the first set of cells 110, and provides the fourth set of cells 110 with a third interference mitigation configuration indicating that, for a given frame antenna tilting is to be applied in slot 6. In this way, interference caused by the second, third, and fourth sets of cells 110 to the first set of cells 110 may be reduced. As further shown, cells 110 not included in the first set of cells 110, the second set of cells 110, the third set of cells, or the fourth set of cells 110 (e.g., cells 110 in Zone E; outside of Zone A, Zone B, Zone C, and Zone D) may operate normally according to the second (e.g., default) TDD configuration.

As indicated above, FIGS. 1A-ID are provided as an example. Other examples may differ from what is described with regard to FIGS. 1A-1D. The number and arrangement of devices and networks shown in FIGS. 1A-1D are provided as an example. In practice, there may be additional devices and networks, fewer devices and networks, different devices and networks, or differently arranged devices and networks than those shown in FIGS. 1A-1D. Furthermore, two or more devices or networks shown in FIGS. 1A-1D may be implemented within a single device or network, or a single device or network shown in FIGS. 1A-1D may be implemented as multiple, distributed devices or networks. Additionally, or alternatively, a set of devices or a set of networks (e.g., one or more devices or one or more networks) shown in FIGS. 1A-1D may perform one or more functions described as being performed by another set of devices or networks shown in FIGS. 1A-1D.

FIG. 2 is a diagram of an example environment 200 in which systems and/or methods, described herein, can be implemented. As shown in FIG. 2, environment 200 can include a control device 105, a group of cells 110 in a RAN 115, one or more user equipments (UEs) 205, one or more base stations 210 (e.g., each associated with one or more cell 110), a core network 215, and one or more data networks 220. Devices of environment 200 can interconnect via wired connections, wireless connections, or a combination of wired and wireless connections.

Control device 105 includes a device capable of performing techniques associated with dynamic use of TDD, as described herein. In some implementations, the control device 105 may include, for example, a network data analytics function (NWDAF) and/or a self-organizing network (SON) function. The SON function and/or the NWDAF may be configured to provide, for example, lifecycle management, placement, and/or configuration of network resources; scale up or down network resources; coverage and capacity optimization for the network; mobility robustness for the network; provide anomaly detection, diagnosis, and/or healing for the network; automatic neighbor relation setup for the network; resource identifier allocation for the network; and/or the like. In some implementations, the control device 105 may be included in the RAN 115. Additionally, or alternatively, the control device 105 may in some implementations be external to the RAN 115.

RAN 115 includes one or more devices capable of communicating with UE 205 using a cellular RAT. For example, RAN 115 can include one or more base stations 210, which may include, for example, a base transceiver station, radio base station, a node B, an evolved node B (eNB), a gNB, a base station subsystem, a cellular site, a cellular tower (e.g., a cell phone tower, a mobile phone tower, and/or the like), an access point, a transmit receive point (TRP), a radio access node, a macrocell base station, a microcell base station, a picocell base station, a femtocell base station, or another similar type of device. In some implementations, as indicated in FIG. 2, the RAN 115 comprises a group of cells 110, where each cell 110 is supported by a base station 210. Thus, as shown, base stations 210 of the RAN 115 can provide one or more cells 110 that cover geographic areas. In some implementations, RAN 115 can transfer traffic between UE 205 (e.g., using a cellular RAT), one or more other RANs 115 (e.g., using a wireless interface or a backhaul interface, such as a wired backhaul interface), and/or core network 215.

In some implementations, RAN 115 (e.g., one or more devices included in RAN 115, such as one or more base stations 210) can perform scheduling and/or resource management for UEs 205 covered by RAN 115 (e.g., UEs 205 covered by a cell 110 provided by RAN 115). In some implementations, RAN 115 can be controlled or coordinated by a network controller (e.g., control device 105), which can perform load balancing, network-level configuration, and/or the like. The network controller can communicate with RAN 115 via a wireless or wireline backhaul. In some implementations, RAN 115 can include a network controller, a SON module or component, or a similar module or component. In other words, RAN 115 can perform network control, scheduling, and/or network management functions (e.g., for other RAN 115 and/or for uplink, downlink, and/or sidelink communications of UEs 205 covered by RAN 115). In some implementations, RAN 115 can apply network slice policies to perform the network control, scheduling, and/or network management functions. In some implementations, RAN 115 can include a central unit and multiple distributed units. The central unit can coordinate access control and communication with regard to the multiple distributed units. The multiple distributed units can provide UEs 205 and/or other RANs 115 with access to data network 220 via core network 215.

UE 205 includes one or more devices capable of communicating with RAN 115 and/or a data network 220 (e.g., via core network 215). For example, UE 205 can include a wireless communication device, a radiotelephone, a personal communications system (PCS) terminal (e.g., that can combine a cellular radiotelephone with data processing and data communications capabilities), a smart phone, a laptop computer, a tablet computer, a personal gaming system, user equipment, and/or a similar device. UE 205 can be capable of communicating using uplink (e.g., UE to RAN) communications, downlink (e.g., RAN to UE) communications, and/or sidelink (e.g., UE-to-UE) communications. In some implementations, UE 205 can include a machine-type communication (MTC) UE, such as an evolved or enhanced MTC (eMTC) UE. In some implementations, UE 205 can include an Internet of things (IoT) UE, such as a narrowband IoT (NB-IoT) UE and/or the like.

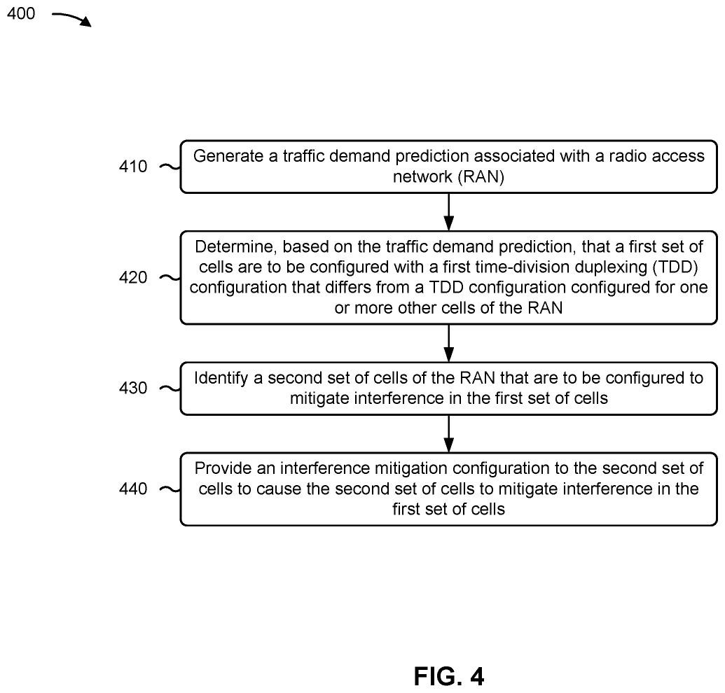

Core network 215 includes various types of core network architectures, such as a 5G Next Generation (NG) Core, a Long-Term Evolution (LTE) Evolved Packet Core (EPC), and/or the like. In some implementations, core network 215 can be implemented on physical devices, such as a gateway, a mobility management entity, and/or the like. In some implementations, the hardware and/or software implementing core network 215 can be virtualized (e.g., through the use of network function virtualization and/or software-defined networking), thereby allowing for the use of composable infrastructure when implementing core network 215. In this way, networking, storage, and compute resources can be allocated to implement the functions of core network 215 (described with regard to FIG. 4) in a flexible manner as opposed to relying on dedicated hardware and software to implement these functions.

Data network 220 includes one or more wired and/or wireless data networks. For example, data network 220 can include an IP Multimedia Subsystem (IMS), a public land mobile network (PLMN), a local area network (LAN), a wide area network (WAN), a metropolitan area network (MAN), a private network such as a corporate intranet, an ad hoc network, the Internet, a fiber optic-based network, a cloud computing network, a third party services network, an operator services network, and/or the like, and/or a combination of these or other types of networks.

The number and arrangement of devices and networks shown in FIG. 2 are provided as an example. In practice, there can be additional devices and/or networks, fewer devices and/or networks, different devices and/or networks, or differently arranged devices and/or networks than those shown in FIG. 2. Furthermore, two or more devices shown in FIG. 2 can be implemented within a single device, or a single device shown in FIG. 2 can be implemented as multiple, distributed devices. Additionally, or alternatively, a set of devices (e.g., one or more devices) of environment 200 can perform one or more functions described as being performed by another set of devices of environment 200.

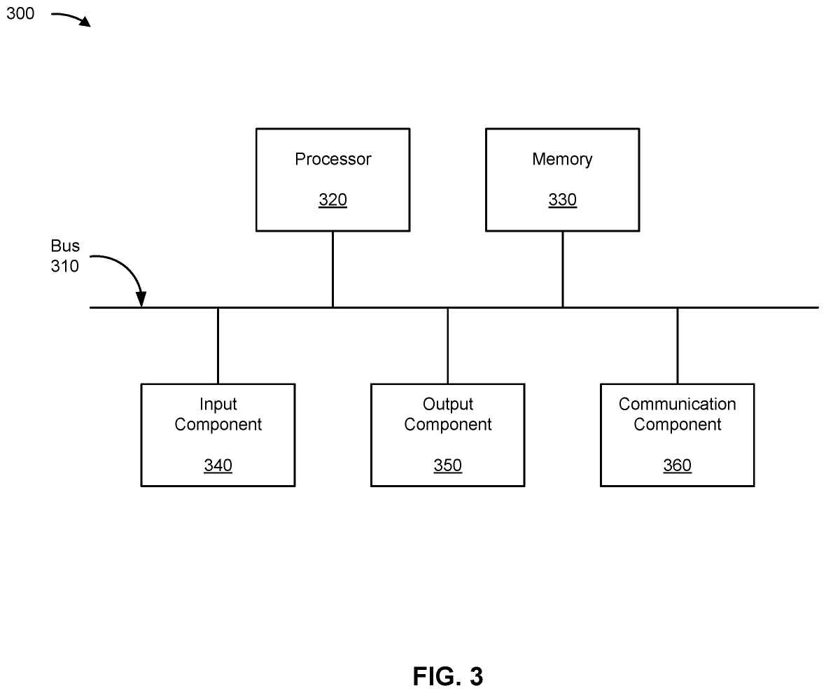

FIG. 3 is a diagram of example components of a device 300 associated with dynamic use of TDD. The device 300 may correspond to a control device 105, a device that supports a cell 110 (e.g., a base station 210), and/or a device included in a RAN 115 (e.g., a base station 210). In some implementations, the control device 105, the device that supports the cell 110, and/or the device included in the RAN 115 may include one or more devices 300 and/or one or more components of the device 300. As shown in FIG. 3, the device 300 may include a bus 310, a processor 320, a memory 330, an input component 340, an output component 350, and/or a communication component 360.

The bus 310 may include one or more components that enable wired and/or wireless communication among the components of the device 300. The bus 310 may couple together two or more components of FIG. 3, such as via operative coupling, communicative coupling, electronic coupling, and/or electric coupling. For example, the bus 310 may include an electrical connection (e.g., a wire, a trace, and/or a lead) and/or a wireless bus. The processor 320 may include a central processing unit, a graphics processing unit, a microprocessor, a controller, a microcontroller, a digital signal processor, a field-programmable gate array, an application-specific integrated circuit, and/or another type of processing component. The processor 320 may be implemented in hardware, firmware, or a combination of hardware and software. In some implementations, the processor 320 may include one or more processors capable of being programmed to perform one or more operations or processes described elsewhere herein.

The memory 330 may include volatile and/or nonvolatile memory. For example, the memory 330 may include random access memory (RAM), read only memory (ROM), a hard disk drive, and/or another type of memory (e.g., a flash memory, a magnetic memory, and/or an optical memory). The memory 330 may include internal memory (e.g., RAM, ROM, or a hard disk drive) and/or removable memory (e.g., removable via a universal serial bus connection). The memory 330 may be a non-transitory computer-readable medium. The memory 330 may store information, one or more instructions, and/or software (e.g., one or more software applications) related to the operation of the device 300. In some implementations, the memory 330 may include one or more memories that are coupled (e.g., communicatively coupled) to one or more processors (e.g., processor 320), such as via the bus 310. Communicative coupling between a processor 320 and a memory 330 may enable the processor 320 to read and/or process information stored in the memory 330 and/or to store information in the memory 330.

The input component 340 may enable the device 300 to receive input, such as user input and/or sensed input. For example, the input component 340 may include a touch screen, a keyboard, a keypad, a mouse, a button, a microphone, a switch, a sensor, a global positioning system sensor, an accelerometer, a gyroscope, and/or an actuator. The output component 350 may enable the device 300 to provide output, such as via a display, a speaker, and/or a light-emitting diode. The communication component 360 may enable the device 300 to communicate with other devices via a wired connection and/or a wireless connection. For example, the communication component 360 may include a receiver, a transmitter, a transceiver, a modem, a network interface card, and/or an antenna.

The device 300 may perform one or more operations or processes described herein. For example, a non-transitory computer-readable medium (e.g., memory 330) may store a set of instructions (e.g., one or more instructions or code) for execution by the processor 320. The processor 320 may execute the set of instructions to perform one or more operations or processes described herein. In some implementations, execution of the set of instructions, by one or more processors 320, causes the one or more processors 320 and/or the device 300 to perform one or more operations or processes described herein. In some implementations, hardwired circuitry may be used instead of or in combination with the instructions to perform one or more operations or processes described herein. Additionally, or alternatively, the processor 320 may be configured to perform one or more operations or processes described herein. Thus, implementations described herein are not limited to any specific combination of hardware circuitry and software.

The number and arrangement of components shown in FIG. 3 are provided as an example. The device 300 may include additional components, fewer components, different components, or differently arranged components than those shown in FIG. 3. Additionally, or alternatively, a set of components (e.g., one or more components) of the device 300 may perform one or more functions described as being performed by another set of components of the device 300.

FIG. 4 is a flowchart of an example process 400 associated with dynamic use of TDD. In some implementations, one or more process blocks of FIG. 4 may be performed by a control device (e.g., control device 105). In some implementations, one or more process blocks of FIG. 4 may be performed by another device or a group of devices separate from or including the control device, such as a device associated with a RAN (e.g., a base station 210 included in a RAN 115). Additionally, or alternatively, one or more process blocks of FIG. 4 may be performed by one or more components of device 300, such as processor 320, memory 330, input component 340, output component 350, and/or communication component 360.

As shown in FIG. 4, process 400 may include generating a traffic demand prediction associated with a RAN (block 410). For example, the control device may generate a traffic demand prediction associated with a RAN (e.g., a RAN 115), as described above.

In some implementations, the traffic demand prediction is generated based on one or more historical performance metrics associated with cells of the RAN. The one or more historical performance metrics include, for example, at least one of a downlink PRB usage metric, an uplink PRB usage metric, a downlink data volume metric, or an uplink data volume metric.

Additionally, or alternatively, the traffic demand prediction may be generated based on event information associated with an area corresponding to at least one cell.

As further shown in FIG. 4, process 400 may include determining, based on the traffic demand prediction, that a first set of cells of the RAN are to be configured with a first TDD configuration that differs from a second TDD configuration configured for one or more other cells of the RAN (block 420). For example, the control device may determine, based on the traffic demand prediction, that a first set of cells of the RAN are to be configured with a first TDD configuration that differs from a second TDD configuration configured for one or more other cells of the RAN, as described above.

In some implementations, the traffic demand prediction indicates a start time for implementation of the first TDD configuration and an end time for implementation of the first TDD configuration.

In some implementations, the first TDD configuration has a higher uplink slot to downlink slot ratio than the second TDD configuration configured for the one or more other cells.

Additionally, or alternatively, a format of one or more slots in the first TDD configuration may be different from a format of one or more corresponding slots in the second TDD configuration configured for the one or more other cells.

In some implementations, the first TDD configuration indicates a start time associated with the first TDD configuration and an end time associated with the first TDD configuration.

As further shown in FIG. 4, process 400 may include identifying a second set of cells of the RAN that are to be configured to mitigate interference in the first set of cells (block 430). For example, the control device may identify a second set of cells of the RAN that are to be configured to mitigate interference in the first set of cells, as described above.

In some implementations, a cell in the second set of cells is identified based on a set of characteristics associated with the cell. The set of characteristics may include, for example, at least one of a location of the cell, a transmit power of the cell, an azimuth associated with the cell, an antenna pattern associated with the cell, a morphology associated with the cell, or a propagation model associated with the cell.

As further shown in FIG. 4, process 400 may include providing an interference mitigation configuration to the second set of cells to cause the second set of cells to mitigate interference in the first set of cells (block 440). For example, the control device may provide an interference mitigation configuration to the second set of cells to cause the second set of cells to mitigate interference in the first set of cells, as described above.

In some implementations, process 400 includes identifying an interference threshold for the first set of cells, and determining the interference mitigation configuration based on the interference threshold, where the interference mitigation configuration is determined so as to prevent interference to the first set of cells from exceeding the interference threshold.

In some implementations, the interference mitigation configuration indicates one or more slots that are not to be scheduled.

Additionally, or alternatively, the interference mitigation configuration may indicate one or more slots in which at least one of beamforming, antenna tilting, or transmit power reduction is to be applied.

Further, in some implementations, the interference mitigation configuration indicates a start time for implementation of the interference mitigation configuration and an end time for implementation of the interference mitigation configuration.

In some implementations, process 400 includes providing the first TDD configuration to the first set of cells.

Additionally, or alternatively, the interference mitigation configuration in some implementations is a first interference mitigation configuration, and process 400 further comprises identifying a third set of cells that are to be configured to mitigate interference in the first set of cells, and providing a second interference mitigation configuration to the third set of cells to cause the third set of cells to mitigate interference in the first set of cells.

Although FIG. 4 shows example blocks of process 400, in some implementations, process 400 may include additional blocks, fewer blocks, different blocks, or differently arranged blocks than those depicted in FIG. 4. Additionally, or alternatively, two or more of the blocks of process 400 may be performed in parallel.

As used herein, the term “component” is intended to be broadly construed as hardware, firmware, or a combination of hardware and software. It will be apparent that systems and/or methods described herein may be implemented in different forms of hardware, firmware, and/or a combination of hardware and software. The actual specialized control hardware or software code used to implement these systems and/or methods is not limiting of the implementations. Thus, the operation and behavior of the systems and/or methods are described herein without reference to specific software code—it being understood that software and hardware can be used to implement the systems and/or methods based on the description herein.

As used herein, satisfying a threshold may, depending on the context, refer to a value being greater than the threshold, greater than or equal to the threshold, less than the threshold, less than or equal to the threshold, equal to the threshold, not equal to the threshold, or the like.

Even though particular combinations of features are recited in the claims and/or disclosed in the specification, these combinations are not intended to limit the disclosure of various implementations. In fact, many of these features may be combined in ways not specifically recited in the claims and/or disclosed in the specification. Although each dependent claim listed below may directly depend on only one claim, the disclosure of various implementations includes each dependent claim in combination with every other claim in the claim set. As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiple of the same item.

No element, act, or instruction used herein should be construed as critical or essential unless explicitly described as such. Also, as used herein, the articles “a” and “an” are intended to include one or more items, and may be used interchangeably with “one or more.” Further, as used herein, the article “the” is intended to include one or more items referenced in connection with the article “the” and may be used interchangeably with “the one or more.” Furthermore, as used herein, the term “set” is intended to include one or more items (e.g., related items, unrelated items, or a combination of related and unrelated items), and may be used interchangeably with “one or more.” Where only one item is intended, the phrase “only one” or similar language is used. Also, as used herein, the terms “has,” “have,” “having,” or the like are intended to be open-ended terms. Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

In the preceding specification, various example embodiments have been described with reference to the accompanying drawings. It will, however, be evident that various modifications and changes may be made thereto, and additional embodiments may be implemented, without departing from the broader scope of the invention as set forth in the claims that follow. The specification and drawings are accordingly to be regarded in an illustrative rather than restrictive sense.

What is claimed is:

1. A method, comprising:
generating, by a device, a traffic demand prediction associated with a radio access network (RAN);
determining, by the device and based on the traffic demand prediction, that a first set of cells of the RAN are to be configured with a first time-division duplexing (TDD) configuration that differs from a second TDD configuration configured for one or more other cells of the RAN;
identifying, by the device, a second set of cells of the RAN that are to be configured to mitigate interference in the first set of cells; and
providing, by the device, an interference mitigation configuration to the second set of cells to cause the second set of cells to mitigate interference in the first set of cells.

2. The method of claim 1, wherein the traffic demand prediction is generated based on one or more historical performance metrics associated with cells of the RAN.

3. The method of claim 2, wherein the one or more historical performance metrics include at least one of a downlink physical resource block (PRB) usage metric, an uplink PRB usage metric, a downlink data volume metric, or an uplink data volume metric.

4. The method of claim 1, wherein the traffic demand prediction is generated based on event information associated with an area corresponding to at least one cell.

5. The method of claim 1, wherein the traffic demand prediction indicates a start time for implementation of the first TDD configuration and an end time for implementation of the first TDD configuration.

6. The method of claim 1, wherein the first TDD configuration has a higher uplink slot to downlink slot ratio than the second TDD configuration configured for the one or more other cells.

7. The method of claim 1, wherein a format of one or more slots in the first TDD configuration is different from a format of one or more corresponding slots in the second TDD configuration configured for the one or more other cells.

8. The method of claim 1, wherein a cell in the second set of cells is identified based on a set of characteristics associated with the cell.

9. The method of claim 8, wherein the set of characteristics includes at least one of a location of the cell, a transmit power of the cell, an azimuth associated with the cell, an antenna pattern associated with the cell, a morphology associated with the cell, or a propagation model associated with the cell.

10. The method of claim 1, further comprising:
identifying an interference threshold for the first set of cells; and
determining the interference mitigation configuration based on the interference threshold, the interference mitigation configuration being determined so as to prevent interference to the first set of cells from exceeding the interference threshold.

11. The method of claim 1, wherein the interference mitigation configuration indicates one or more slots that are not to be scheduled.

12. The method of claim 1, wherein the interference mitigation configuration indicates one or more slots in which at least one of beamforming, antenna tilting, or transmit power reduction is to be applied.

13. The method of claim 1, wherein the interference mitigation configuration indicates a start time for implementation of the interference mitigation configuration and an end time for implementation of the interference mitigation configuration.

14. The method of claim 1, further comprising providing the first TDD configuration to the first set of cells.

15. The method of claim 14, wherein the first TDD configuration indicates a start time associated with the first TDD configuration and an end time associated with the first TDD configuration.

16. The method of claim 1, wherein the interference mitigation configuration is a first interference mitigation configuration, and the method further comprises:
identifying a third set of cells that are to be configured to mitigate interference in the first set of cells; and
providing a second interference mitigation configuration to the third set of cells to cause the third set of cells to mitigate interference in the first set of cells.

17. A device, comprising:
one or more processors configured to:
generate a traffic demand prediction associated with a first set of cells;
determine, based on the traffic demand prediction, that the first set of cells are to be configured with a first time-division duplexing (TDD) configuration that differs from a second TDD configuration configured for one or more other cells;
identify a second set of cells that are to be configured to mitigate interference in the first set of cells; and
provide an interference mitigation configuration to the second set of cells to cause the second set of cells to mitigate interference in the first set of cells.

18. The device of claim 17, wherein the traffic demand prediction indicates a start time for implementation of the first TDD configuration and an end time for implementation of the first TDD configuration.

19. The device of claim 17, wherein the one or more processors are further configured to:
identify an interference threshold for the first set of cells; and
determine the interference mitigation configuration based on the interference threshold, the interference mitigation configuration being determined so as to prevent interference caused to the first set of cells from exceeding the interference threshold.

20. A non-transitory computer-readable medium storing a set of instructions, the set of instructions comprising:
one or more instructions that, when executed by one or more processors of a device, cause the device to:
generate a traffic demand prediction associated with a first set of cells;
determine, based on the traffic demand prediction, that the first set of cells are to be configured with a first time-division duplexing (TDD) configuration that differs from a second TDD configuration configured for one or more other cells;
identify a second set of cells that are to be configured to mitigate interference in the first set of cells; and
provide an interference mitigation configuration to the second set of cells to cause the second set of cells to mitigate interference in the first set of cells.
